(19) United States
(12) Patent Application Publication
(10) Pub. No.: US 2025/0168707 A1
(43) Pub. Date: May 22, 2025

(54) HYBRID BANDWIDTH MULTI-USER MULTIPLE-INPUT, MULTIPLE-OUTPUT TRANSMISSION AND SIGNALING

(71) Applicant: NXP USA, Inc., AUSTIN, TX (US)

(72) Inventors: Ankit Sethi, Pune (IN); Sachin Mohan Pottigari, Sangareddy (IN); Rui Cao, Sunnyvale, CA (US); Sayak Roy, Kolkata (IN); Sudhir Srinivasa, Los Gatos, CA (US)

(21) Appl. No.: 18/955,185

(22) Filed: Nov. 21, 2024

(30) Foreign Application Priority Data
Nov. 22, 2023 (IN) 202341079330
Jan. 17, 2024 (IN) 202441003431

(51) Int. Cl. H04W 28/20

(52) U.S. Cl. CPC H04W 28/20

(57) ABSTRACT

Embodiments of a wireless device and method are disclosed. In an embodiment, a wireless device comprises a wireless transceiver arranged to receive and transmit signals, and a controller operably coupled to the wireless transceiver to process the signals, wherein the controller is configured to transmit the signals to different end devices using different sized bandwidths, wherein the signals transmitted to a first end device use a first bandwidth of a first size and the signals transmitted to a first end device use a second bandwidth of a second size.

### CROSS-REFERENCE TO RELATED APPLICATIONS

This application is entitled to the benefit of Indian Provisional Patent Application Number 202441003431, filed on Jan. 17, 2024, and Indian Provisional Patent Application Number 202341079330, filed on Nov. 22, 2023, which are incorporated herein by reference.

### BACKGROUND

The WiFi standards developed (WiFi 7 being the latest) only support pure bandwidth (BW) Multi-User Multiple-Input, Multiple-Output (MUMIMO) or Orthogonal Frequency-Division Multiple Access (OFDMA)-MUMIMO, where the BW of the intended signal for all users participating in MUMIMO is the same. In addition, the existing WiFi standards only support the same number of streams across BW of the intended signal for a given user. In the MIMO-OFDMA feature, which was introduced in WiFi 6 and beyond, different segments of BW can have different number of streams but the number of streams across BW for every user must be the same.

### SUMMARY

Embodiments of a wireless device and method are disclosed. In an embodiment, a wireless device comprises a wireless transceiver arranged to receive and transmit signals, and a controller operably coupled to the wireless transceiver to process the signals, wherein the controller is configured to transmit the signals to different end devices using different sized bandwidths, wherein the signals transmitted to a first end device use a first bandwidth of a first size and the signals transmitted to a first end device use a second bandwidth of a second size.

In an embodiment, the controller is configured to transmit the signals to different end devices on different spatial streams using different sized bandwidths.

In an embodiment, the controller is configured to use a universal signal (USIG) to transmit information associated with transmission of the signals to the different end devices using the different sized bandwidths.

In an embodiment, the controller is configured to use an Extreme High Throughput Signal (EHTSIG) to transmit information associated with transmission of the signals to the different end devices using the different sized bandwidths.

In an embodiment, the controller is configured to use at least one new field of a Physical Layer Convergence Protocol (PLCP) Protocol Data Unit (“PPDU”) to transmit information associated with transmission of the signals to the different end devices using the different sized bandwidths.

In an embodiment, the controller is configured to use a new common info field and a new user info field of the PPDU to transmit information associated with transmission of the signals to the different end devices using the different sized bandwidths.

In an embodiment, the new common info field indicates a total number of end devices present.

In an embodiment, the controller is configured to use multiple user info fields of the PPDU equal to the number of the different end devices, and wherein each of the multiple user info fields includes information of a specific end device.

In an embodiment, the controller is configured to transmit the signals to the different end devices using different numbers of spatial streams for each end device.

In an embodiment, a method of transmitting signals to different end devices from a wireless device in a communications system comprises transmitting the signals to a first end device from the wireless device using a first bandwidth of a first size, and transmitting the signals to a second end device from the wireless device using a second bandwidth of a second size.

In an embodiment, transmitting the signals to the second end device from the wireless device includes transmitting the signals to the second end device on different spatial streams using different sized bandwidths.

In an embodiment, the method further comprises utilizing a universal signal (USIG) to transmit information associated with transmission of the signals to the first and second end devices.

In an embodiment, the method further comprises utilizing an Extreme High Throughput Signal (EHTSIG) to transmit information associated with transmission of the signals to the first and second end devices.

In an embodiment, the method further comprises utilizing at least one new field of a Physical Layer Convergence Protocol (PLCP) Protocol Data Unit (“PPDU”) to transmit information associated with transmission of the signals to the first and second end devices.

In an embodiment, utilizing the at least one new field of the frame includes utilizing a new common info field and a new user info field of the PPDU to transmit the information associated with the transmission of the signals to the first and second end devices.

In an embodiment, the new common info field indicates a total number of end devices present.

In an embodiment, utilizing the at least one new field of the frame includes utilizing multiple user info fields of the PPDU equal to the number of the different end devices, and wherein each of the multiple user info fields includes information of a specific end device.

In an embodiment, transmitting the signals to the first and second end devices from the wireless device includes transmitting the signals to the first and second end devices using different numbers of spatial streams.

In an embodiment, a wireless device comprises a wireless transceiver arranged to receive and transmit signals and a controller operably coupled to the wireless transceiver to process the signals, wherein the controller is configured to spatially multiplex the signals to different end devices using different sized bandwidths in a total available bandwidth, wherein the signals transmitted to a first end device use a first bandwidth of a first size and the signals transmitted to a second end device use a second bandwidth of a second size.

In an embodiment, the controller is configured to transmit the signals to the different end devices using different numbers of spatial streams such that a first number of spatial streams is used for one of the different end devices and a second number of spatial streams is used for another one of the different end devices.

Other aspects in accordance with the invention will become apparent from the following detailed description, taken in conjunction with the accompanying drawings, illustrated by way of example of the principles of the invention.

### BRIEF DESCRIPTION OF DRAWINGS

FIG. 1 depicts a multi-link communications system for wireless communications that can be used in embodiments of the invention.

FIG. 2 illustrates a hybrid BW MUMIMO in large BWs in a first scenario in accordance with an embodiment of the invention.

FIG. 3 illustrates the system throughput for the current 11 be (R1) (Option 1), the current 11 be (R1) (Option 2) and the hybrid BW MUMIMO.

FIG. 4 illustrates the hybrid BW MUMIMO in large BWs in a second scenario in accordance with an embodiment of the invention.

FIG. 5 illustrates the system throughput the current WiFi 7 (Option 1), the current WiFi 7 (Option 2), and the hybrid BW MUMIMO.

FIG. 6 illustrates the hybrid BW MUMIMO in large BWs in a third scenario in accordance with an embodiment of the invention.

FIG. 7 illustrates the system throughput the current WiFi 7 and the hybrid BW MUMIMO.

FIG. 8 illustrates an example of Extreme High Throughput Signal (EHTSIG) common field signaling in accordance with an embodiment of the invention.

FIG. 9 illustrates different position patterns in accordance with an embodiment of the invention.

FIG. 10 shows an AP transmitter (Tx) architecture for the hybrid BW MUMIMO in accordance with an embodiment of the invention.

FIG. 11 shows an AP Tx architecture for the hybrid BW MUMIMO for unequal Modulation Coding Scheme (MCS) across sub-bands in accordance with an embodiment of the invention.

FIG. 12 illustrates an example of a single user (SU) scenario in accordance with an embodiment of the invention.

FIG. 13 illustrates the throughput for current three (3) WiFi 7 options and the SU with unequal number of spatial streams (Nss).

FIG. 14 illustrates an example of a hybrid MUMIMO with unequal Nss SU scenario in accordance with an embodiment of the invention.

FIG. 15 illustrates the throughput for current two (2) WiFi 7 options, the hybrid BW MUMIMO and the hybrid BW MUMIMO with the unequal Nss support configuration.

FIG. 16 shows a TX architecture for unequal streams support in accordance with an embodiment of the invention.

FIG. 17 shows a receiver (RX) architecture for different numbers of streams per 80 MHz band for SU in accordance with an embodiment of the invention.

FIG. 18 depicts a wireless device in accordance with an embodiment of the invention.

FIG. 19 illustrates a flow diagram of a method of transmitting signals to different end devices from a wireless device in a communications system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

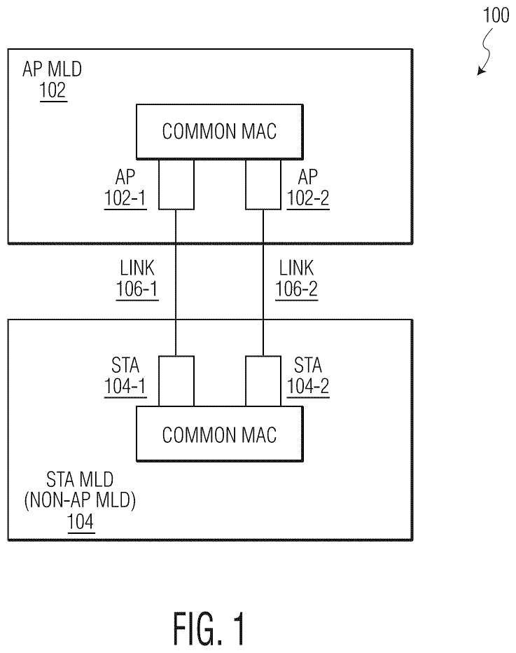

FIG. 1 depicts a multi-link communications system 100 for wireless (e.g., WiFi) communications that can be used in embodiments of the invention. In the embodiment depicted in FIG. 1, the multi-link communications system includes one access point (AP) multi-link device (MLD) 102, and one station (STA) MLD (non-AP MLD) 104. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Various iterations of the 802.11 specification are referred to herein. IEEE 802.11ac is referred to as very high throughput (VHT). IEEE 802.11ax is referred to as high efficiency (HE). IEEE 802.11be (also known as “WiFi 7”) is referred to as extreme high throughput (EHT). IEEE 802.11bn (also known as “WiFi 8”) is referred to as ultra-high reliability (UHR). The terms VHT, HE, EHT, and UHR may be used in the descriptions found herein.

Although the depicted multi-link communications system 100 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiments, an AP MLD may have a single affiliated AP. In some embodiments, a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 102 includes two access points (APs) 102-1 and 102-2. In some embodiments, the AP MLD 102 implements upper layer Media Access Control (MAC) functionalities (e.g., association establishment, reordering of frames, etc.) and the APs 102-1 and 102-2 implement lower layer MAC functionalities (e.g., backoff, frame transmission, frame reception, etc.). The 102-1 and 102-2 may be implemented in hardware (e.g., circuits), software, firmware, or a combination thereof. The APs 102-1 and 102-2 may be fully or partially implemented as an integrated circuit (IC) device. In some embodiments, the APs 102-1 and 102-2 may be wireless APs compatible with at least one WLAN communications protocol (e.g., at least one IEEE 802.11 protocol). For example, the APs 102-1 and 102-2 may be wireless APs compatible with the IEEE 802.11bn protocol.

In some embodiments, an AP MLD 102 connects to a local area network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 102-1 and/or AP2 102-2) includes multiple radio frequency (RF) chains. In some embodiments, an AP (e.g., AP1 102-1 and/or AP2 102-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 102-1 and 102-2 of the AP MLD 102 with multiple RF chains may operate in a different basic service set (BSS) operating channel (in a different link). For example, AP1 102-1 may operate in a 320 MHz BSS operating channel at 6 GHz band, and AP2 102-2 may operate in a 160 MHz BSS operating channel at 5 GHz band. Although the AP MLD 102 is shown in FIG. 1 as including two APs, other embodiments of the AP MLD 102 may include only one AP or more than two APs.

In the embodiment depicted in FIG. 1, the non-AP STA MLD 104 includes two non-AP STAs 104-1 and 104-2. The STAs 104-1 and 104-2 may be implemented in hardware (e.g., circuits), software, firmware, or a combination thereof. The STAs 104-1 and 104-2 may be fully or partially implemented as an IC device. In some embodiments, the STAs 104-1 and 104-2 are part of the STA MLD 104, such that the STA MLD may be a communications device that wirelessly connects to a wireless AP MLD. For example, the STA MLD 104 may be implemented in a laptop, a desktop personal computer (PC), a mobile phone, or other communications device that supports at least one WLAN communications protocol. In some embodiments, the non-AP STA MLD 104 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 104 implements a common MAC functionality and the non-AP STAs 104-1 and 104-2 implement a lower layer MAC data functionality.

In some embodiments, the AP MLD 102 and/or the STA MLD 104 may identify which communication links support multi-link operation during a multi-link operation setup phase and/or exchanges information regarding multi-link capabilities during the multi-link operation setup phase. In some embodiments, each of the non-AP STAs 104-1 and 104-2 of the STA MLD 104 may operate in a different frequency band. For example, the non-AP STA 104-1 in one link may operate in the 2.4 GHz frequency band and the non-AP STA 104-2 in another link may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 104 communicates with the AP MLD 102 via two communication links 106-1 and 106-2. For example, each of the non-AP STAs 104-1 and 104-2 communicates with an AP 102-1 or 102-2 via a corresponding communication link 106-1 or 106-2. In an embodiment, a communication link (e.g., link 106-1 or link 106-2) may include a BSS operating channel established by an AP (e.g., AP 102-1 or AP 102-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 104 is shown in FIG. 1 as including two non-AP STAs, other embodiments of the STA MLD 13 may include one non-AP STA or more than two non-AP STAs. In addition, although the AP MLD 102 communicates (e.g., wirelessly communicates) with the STA MLD 104 via multiple links 106 and 106-2, in other embodiments, the AP MLD 102 may communicate (e.g., wirelessly communicate) with the STA MLD 104 via one communication link or more than two communication links.

As described above a multi-link AP MLD has one or multiple links where each link has one AP affiliated with the AP MLD. This may be accomplished by having the different radios for the different affiliated APs. A multi-link STA MLD has one or multiple links where each link has one STA affiliated with the STA MLD. One way to implement the multi-link STA MLD is using two or more radios, where each radio is associated with a specific link. For example, a multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case, only one link is available at a time. In yet another implementation, an enhanced single-radio (ESR) STA MLD may be used that operates in an enhanced multi-link single radio (eMLSR) mode. The ESR STA MLD uses two radios in different bands to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PPDU on each link. Each radio may have its own backoff time, and when the backoff counter for one of the radios becomes zero, that radio and link may be used for transmission. For example, if an AP wants to use the fully functional radio, it may send a control frame that is long enough for the ESR STA MLD to switch from the lesser capable radio to the fully functional radio that may then transmit data to the AP. When an extended service set (ESS) includes multiple AP MLDs in different locations and a STA MLD executed the data frame exchanges with one of the AP MLDs (e.g., AP MLD1), as the STA MLD moves to other location to do the data frame exchanges with another one of the AP MLDs (say AP MLD2), the STA MLD (same as a non-AP MLD herein) needs to finish the association with AP MLD2 before doing the data frame exchanges with AP MLD2. There is a requirement to decrease the number of associations within the ESS.

Currently, WiFi 6 and WiFi 7 enable a full BW MUMIMO between AP and STAs (which can be viewed as being end devices). Under this full BW MUMIMO, the same BW of signal is used for all STAs that are grouped together and spatially multiplexed for MU-MIMO. For example, for an AP communicating with four (4) STAs with 160 MHz BW available, spatial multiplexing is performed by the AP on all four (4) STAs over the entire 160 MHz. It is also possible to have “one group of STAs” spatially multiplexed together in one Resource Unit (RU) and “other group of STAs” spatially multiplexed together in another RU. For example, for an AP communicating with four (4) STAs with 160 MHz BW available, spatial multiplexing can be performed for “1^{st} group 2 STAs” over primary 80 MHz and “2^{nd} group of STAs” over secondary 80 MHz.

However, the full BW MUMIMO feature cannot support spatially multiplexing STAs with different signal BW and overlapping bands. For example, for an AP with four (4) STAs with 160 MHz BW available, the full BW MUMIMO cannot support spatial multiplexing performed on 1^{st} STA and 2^{nd} STA with signal BW 160 MHz and 3^{rd} STA and 4^{th} STA with signal BW 80 MHz, where the primary 80 MHz is used for the 3^{rd} STA and the secondary 80 MHz is used for the 4^{th} STA.

In addition, WiFi 6 and WiFi 7 also do not currently support different number of user stream, different number of interference streams, different MCS within intended signal BW of a given user that is spatially multiplexed.

Currently, WiFi 7 supports signal BW up to 320 MHz. However, future standards support may increase support to even higher BW (640 MHz, etc.). For the current WiFi 7, if an AP is to spatially multiplex N STAs in a given BW B (where B may be 640 MHz or higher), the entire BW B should be free for all N STAs. As an example, let's take a scenario where there is an AP with eight (8) antennas that wants to perform MUMIMO by spatially multiplexing four (4) STAs, each with one (1) receiver (Rx) in BW with B=320 MHz. For this to be possible, the entire BW of B=320 MHz should be free for all four (4) STAs. In the field, this becomes less and less likely when the band BW B increases. In dense environments, it is difficult to find the STAs that can be grouped even for B=160 MHz. In addition, all the STAs may not be having support for large BWs (for example, low-power STA devices may support only 80 MHz signal). Also, a particular STA might see different channel/noise/interference quality in different sub-bands of the BW B. This would lead to a different value of optimal MCS and Nss for this user in different sub-bands.

To overcome these issues, in a hybrid BW MUMIMO in accordance with embodiments of the invention, it is possible to spatially multiplex STAs with different signal BWs and support different MCSs, user number of streams (Nsts) and total Nsts (Nsts_total) in different sub-bands within the intended signal BW of a given user. The hybrid BW MUMIMO is now described using examples.

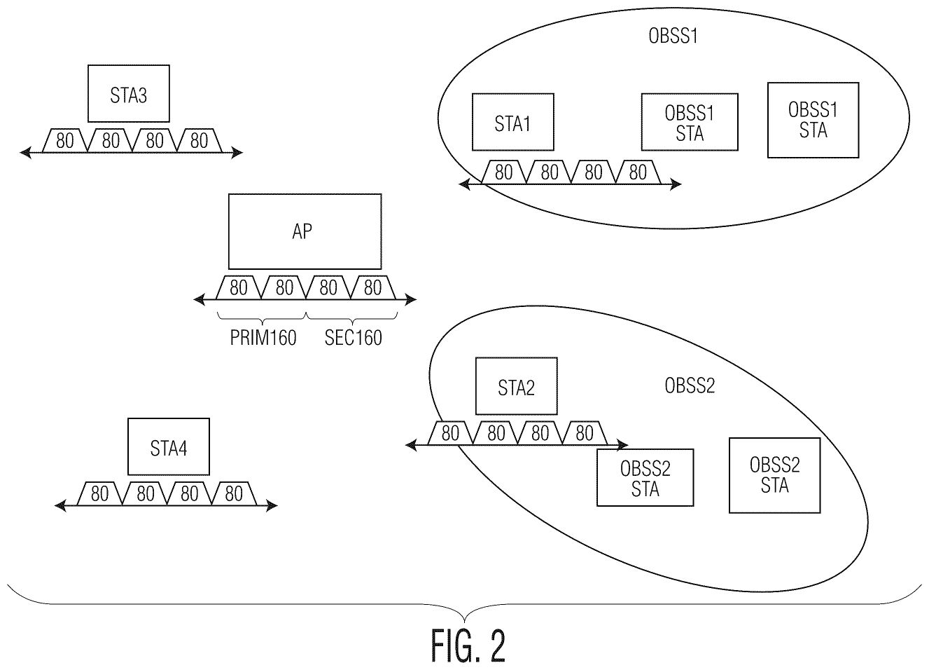

The first example illustrates the hybrid BW MUMIMO in large BWs in a first scenario, which is described with reference to FIG. 2. As shown in FIG. 2, the first scenario involves an AP with eight (8) antennas associated with four (4) STAs (i.e., a first STA (“STA1”), a second STA (“STA2”), a third STA (“STA3”) and a STA4), each with 1Rx, which are all supported with B=320 MHz. The STA1 is in a first Overlapping Basic Service Set (OBSS) (“OBSS1”) with an OBSS1 AP, and the STA2 is in a second OBSS (“OBSS2”) with an OBSS2 AP. For the AP, the entire 320 MHz is available. For the STA1, only the primary 160 MHz is available as OBSS1 transmission is in the secondary 160 MHz. For the STA2, only the secondary 160 MHz is available as OBSS2 transmission is in the primary 160 MHz. For the STA2 and STA4, the entire 320 MHz is available.

Currently, 11be (R1) provides the following two possible best configurations. The first option is spatial multiplex the STA1 and the STA3 in the primary 160 MHz and the STA2 and the STA4 in the secondary 160 MHz. The second option is spatial multiplex the STA1, the STA3 and the STA4 in the primary 160 MHz and the STA2 only in the secondary 160 MHz.

However, the hybrid BW MUMIMO provides the following possible best configuration, which is spatially multiplex the STA1 in the primary 160 MHz for spatial stream (SS)=1, the STA2 in the secondary 160 MHz for SS=1, the STA3 in the entire 320 MHz for SS=2 and the STA 4 in the entire 320 MHz for SS=3. As a result, the hybrid BW MUMIMO can provide 50% more total system throughput as compared to current 11be (R1).

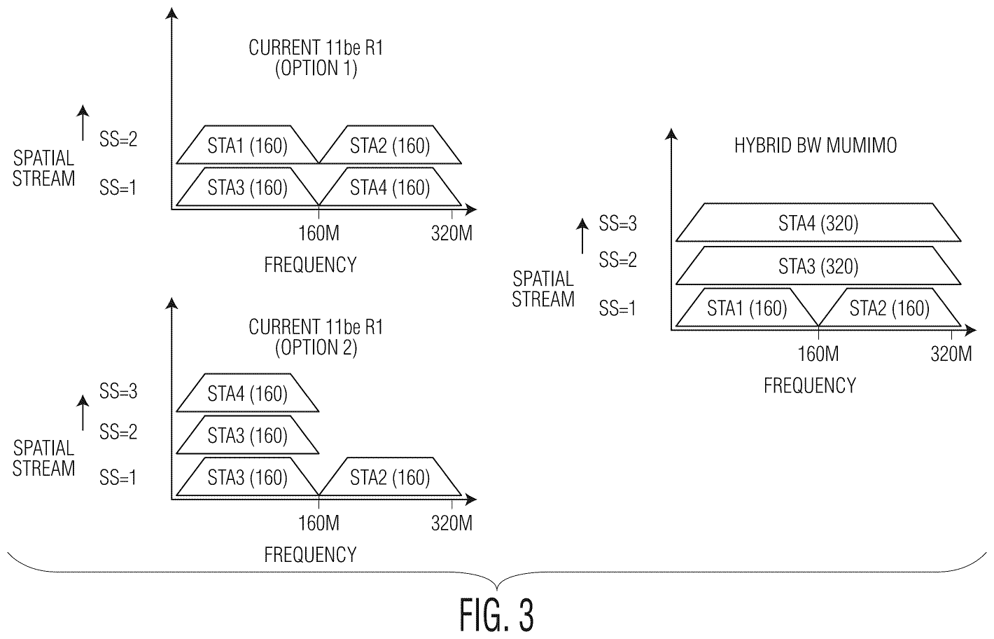

FIG. 3 illustrates the system throughput for the current 11be (R1) (Option 1), the current 11be (R1) (Option 2) and the hybrid BW MUMIMO. If the current 11be (R1) options provide a maximum system throughput of X, then the hybrid BW MUMIMO enables a maximum throughput of 1.5X, (i.e., 50% more).

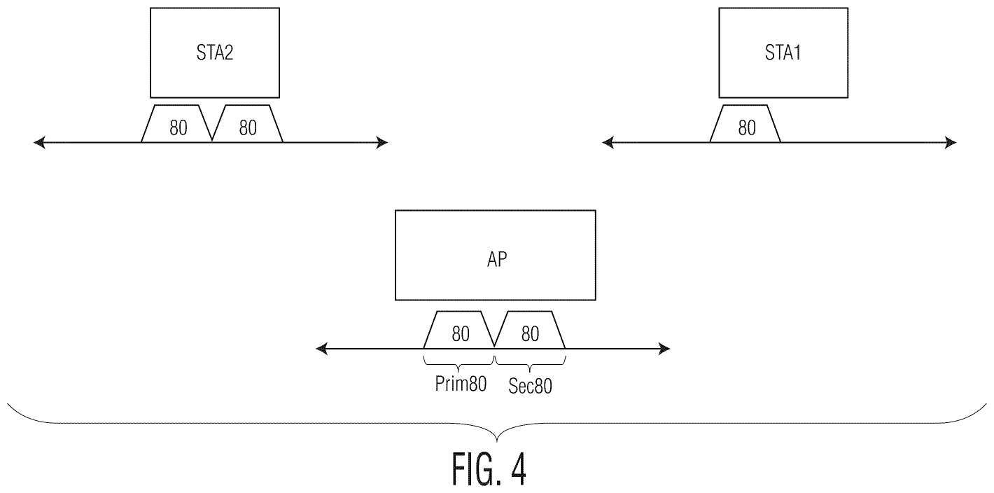

The second example illustrates the hybrid MUMIMO in large BWs in a second scenario, which is described with reference to FIG. 4. As shown in FIG. 4, the second scenario involves an AP with four (4)/eight (8) antennas associated with two (2) STAs (i.e., a STA1 and a STA2), each with 1Rx. For the AP, the entire 160 MHz is available. For the STA1, the device BW is 80 MHz and is available. For the STA2, the device BW is 160 MHz and is available.

Currently, WiFi 7 provides the following possible best configurations. The first option is spatial multiplex the STA1 (for SS=1) and the STA2 (for SS=2) in the primary 80 MHz. The second option is pure OFDMA with the STA1 in the primary 80 MHz and the STA2 in the secondary 80 MHz.

However, the hybrid BW MUMIMO provides the following possible best configuration, which is spatially multiplex the STA2 in the entire 160 MHz for SS=1 and the STA1 in the primary 80 MHz for SS=2 in the entire 160 MHz. As a result, the hybrid BW MUMIMO can provide 100% more total system throughput as compared to current WiFi 7.

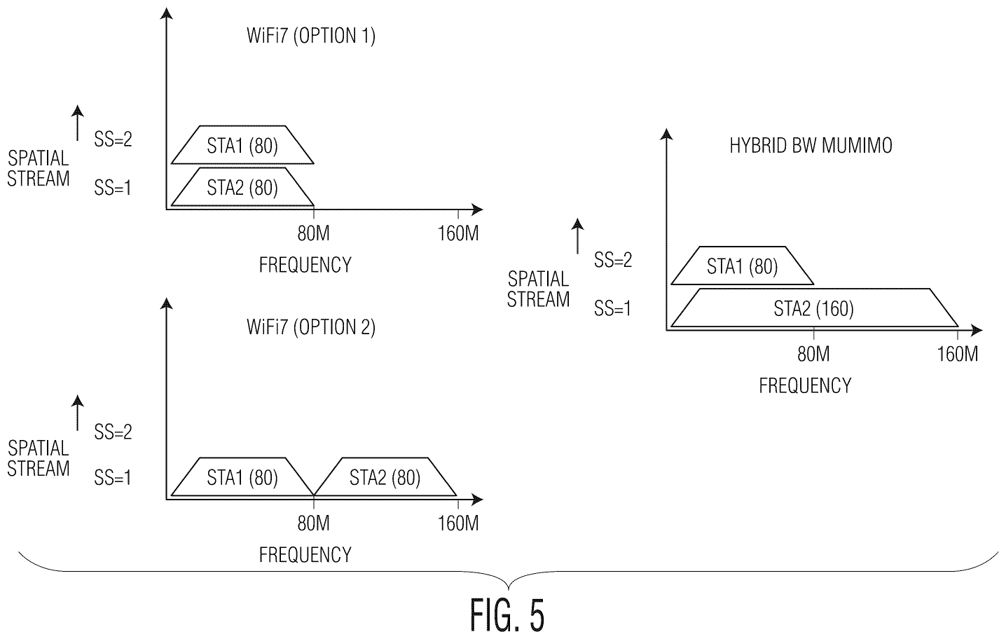

FIG. 5 illustrates the system throughput for the current WiFi 7 (Option 1), the current WiFi 7 (Option 2), and the hybrid BW MUMIMO. If the current WiFi options provide a maximum system throughput of X, then the hybrid BW MUMIMO enables a maximum throughput of 2X, (i.e., 100% more).

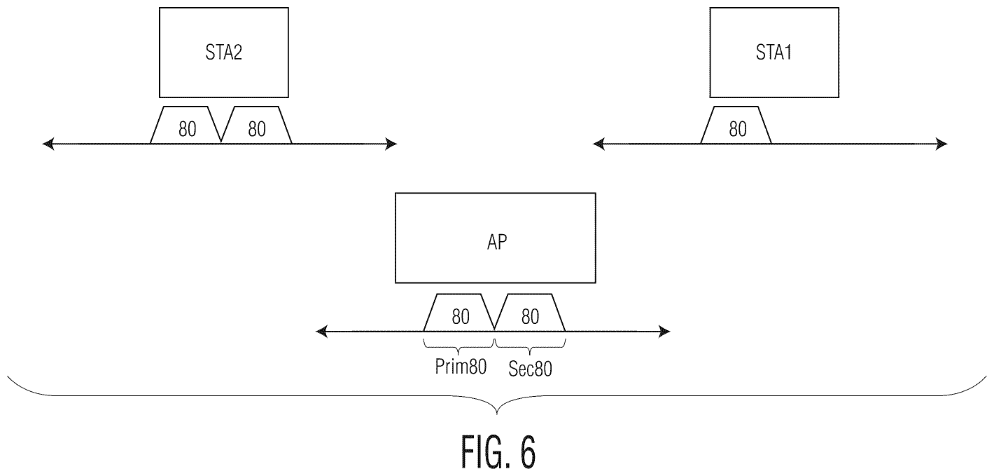

The third example illustrates the hybrid MUMIMO in large BWs in a third scenario, which is described with reference to FIG. 6. As shown in FIG. 6, the third scenario involves an AP with four (4)/eight (8) antennas associated with two (2) STAs, a STA1 with 1 Rx and a STA2 with two (2) RX. For the AP, the entire 160 MHz is available. For the STA1, the device BW is 80 MHz and is available. For the STA2, the device BW is 160 MHz and is available.

Currently, WiFi 7 provides the following possible best configuration for MU. This configuration is pure OFDMA with the STA1 in the primary 80 MHz with single stream and the STA2 in the secondary 80 MHz with two streams.

However, the hybrid BW MUMIMO provides the following possible best configuration, which is spatially multiplex the STA2 in the primary 80 MHz for SS=1 and in the secondary 80 MHz for SS=1 or 2 in the entire 160 MHz, and the STA1 in the secondary 80 MHz for SS=2 in the entire 160 MHz. As a result, the hybrid BW MUMIMO can provide 33% more total system throughput as compared to current WiFi 7.

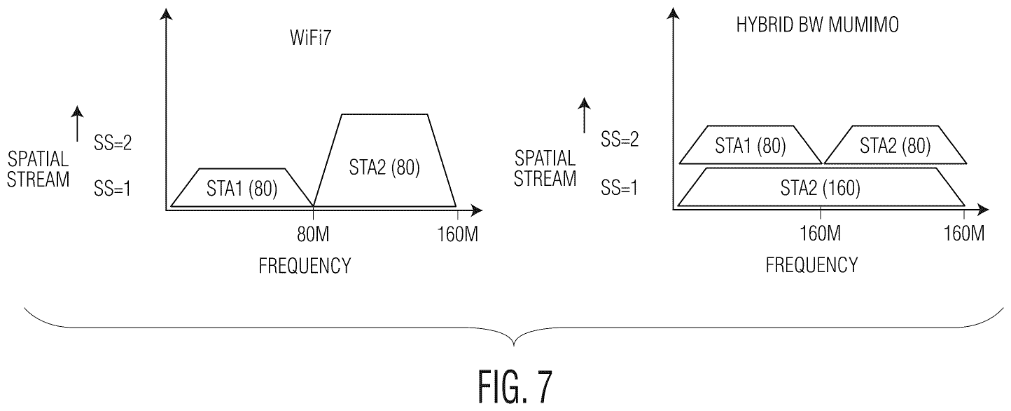

FIG. 7 illustrates the system throughput for the current WiFi 7 and the hybrid BW MUMIMO. If the current WiFi option provides a maximum system throughput of X, then the hybrid BW MUMIMO enables a maximum throughput of 1.33X, (i.e., 33% more).

For signaling the hybrid BW MUMIMO (“Signaling Scheme 1”), a USIG may be used in accordance with an embodiment of the invention. In this embodiment, the WiFi 7 universal signal (USIG) signaling DL-OFDMA may be reused. In particular, USIG1 (B6) is set to 0, and USIG2 (B0-B1) is set to 00. In addition, one of the disregard bits of USIG or Extreme High Throughput Signal Field (EHTSIG) to 0 to indicate hybrid BW MUMIMO signaling that can be interpreted by WiFi 8 (and beyond) users. In particular, any one of the USIG2 (B20-B24) bit is set to 0, and any one of the EHTSIG (B13-B16) bit is set to 0.

For signaling the hybrid BW MUMIMO, the WiFi 7 EHTSIG common field signaling may be reused for DL-OFDMA-MUMIMO in accordance with an embodiment of the invention. In an embodiment, the RU allocation field may be set as follows. The total signal BW is divided into multiple sets, for example, SigBW_Set1 and SigBW_Set2. The SigBW_Set1 is the part of the total signal BW which does not overlap with the hybrid BW MUMIMO signal BW. The RU allocation signaling may follow the WiFi 7 EHTSIG signaling. The SigBW_Set2 is the part of the total signal BW that overlaps with the hybrid BW MUMIMO signal BW. The SigBW_Set2 part is divided into different sub-bands of longest possible length such that each of the data stream in a sub-band spans this entire sub-band and each of data streams in a sub-band map to a unique user (e.g., association identifier (AID)). Each of these sub-bands are treated as separate RUs and the RU allocation field is accordingly constructed (e.g., considering the total number of users present in a sub-band) following WiFi 7 RU allocation signaling. In an embodiment, a new RU allocation signaling to indicate 4×996 tone RU can be indicated by using one of the disregard bit combinations of WiFi 7 RU allocation (e.g., 100110y₂y₁y₀-111111y₂y₁y₀).

In an embodiment, the hybrid BW MUMIMO considers a minimum granularity of such sub-bands to be 80 MHz. However, the hybrid BW MUMIMO can be extended to cases where the minimum granularity of such sub-bands is less than 80 MHz.

For signaling the hybrid BW MUMIMO, the EHTSIG user info field may be used in accordance with an embodiment of the invention. For users allocated in the SigBW_Set1, the WiFi 7 EHTSIG user info signaling for MUMIMO/non-MUMIMO as applicable is used. For users allocated in the SigBW_Set2, for each of the sub-bands in the SigBW_Set2, the WiFi 7 EHTSIG user info signaling of MUMIMO/OFDMA is used considering the users spatially multiplex in this sub-band, their stream indexes and MCSs.

It is noted here, if the total signal BW intended for a user spans multiple sub-bands then this user's AID will be present in multiple User Info fields (one for each of the sub-band that it spans) of a PPDU. Also, it is possible (1) to indicate different MCSs in different sub-bands for a given user, (2) to indicate a different total number of users in different sub-bands of a given user, (3) to indicate different spatial configuration in different sub-bands for a given user, (4) to indicate different stream indexes (e.g., stream start index and stream end index) in different sub-bands for a given user, and (5) to indicate different total number of interference streams in different sub-bands of a given user.

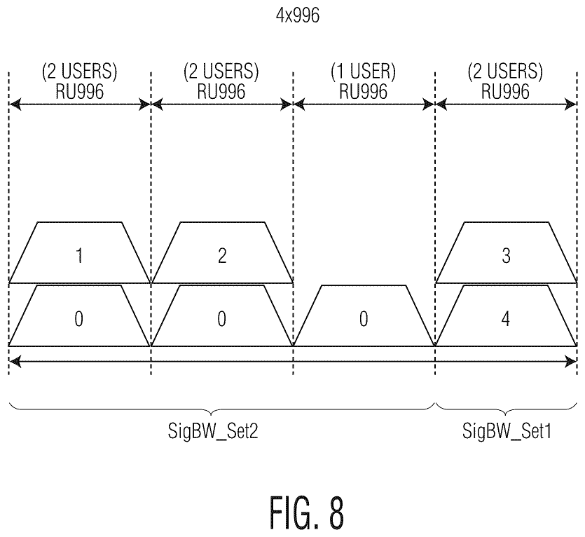

An example of EHTSIG common field signaling in accordance with an embodiment of the invention is described with reference to FIG. 8. As illustrated in FIG. 8, the RU allocation for the SigBW_Set1 (right most RU996): is 00101001 (RU996 with two (2) users). For the RU allocation of the SigBW_Set2 (Right RU996x3), the signal BW is divided into three (3) different sub-bands of RU996. The RU allocation for the left 996 tone sub-band is: 00101001 (RU996 with two (2) users spatially multiplexed). The RU allocation for the middle 996 tone sub-band is: 00101001 (RU996 with two (2) users spatially multiplexed). The RU allocation for the right 996 tone sub-band is: 00101000 (RU996 with 1 user).

With respect to the EHTSIG user info field signaling for the SigBW_Set1, the EHTSIG MUMIMO signaling considering the STA3 (stream index 1) and the STA4 (stream index 0) spatially multiplexed is used. With respect to the EHTSIG user info field signaling for the SigBW_Set2, the signal BW is divided into three (3) different sub-bands of 996 tone RU. For the left 996 tone sub-band, the EHTSIG MUMIMO signaling considering STAG (stream index 0) and STA1 (stream index 1) spatially multiplexed is used. For the middle 996 tone sub-band, the EHTSIG MUMIMO signaling considering STAG (stream index 0) and STA2 (stream index 1) spatially multiplexed is used. For the right 996 tone sub-band, the EHTSIG OFDMA signaling considering STAG with Nss=1 is used.

Benefits and limitations of the signaling scheme 1 will now be described. One of the benefits is that there is limited redesign at Rx, as compared to WiFi 7 design, to interpret and process the signal. Another benefit is that the signaling scheme enables Extreme High Throughput (EHT) STAs to also participate in the hybrid BW MUMIMO transactions. Thus, it assists in enabling parallel communication with cross generation devices present in the environment. Let's consider the example illustrated in FIG. 8. The hybrid BW MUMIMO transaction is in the SigBW_Set2. The signaling scheme 1 is constructed in a way that takes care of backward compatibility with EHT STAs. In this example, the STA 0 always needs to be WiFi 8 complaint. The STAG will find three (3) user info fields with its AID matching. It will stitch the RU allocation across these user info fields to get the complete information about its BW and understand its BW as 3×996 tone RU. The STA1/STA2 can be WiFi 8 and as well as WiFi 7 compliant STAs. These devices will parse RU allocation fields in the SigBW_Set1 and the SigBW_Set2 as what a regular EHT STA does. The STA1/STA2 while parsing the RU allocation fields in the SigBW_Set2 will understand that it is divided into three (3) 996 tone RUs. It is noted here that the STA3 and the STA4 can also be WiFi 8 or WiFi 7 compliant STAs. One of the limitations of the signaling scheme 1 is that STA relevant information can be present across multiple user info fields and a STA thus needs to parse all user info fields in EHTSIG and check which user info field's AID matches with its AID to get complete information about its signal BW, its different sub-bands, the MCSs, Nss and interference stream information that it would see in different sub-bands.

For signaling the hybrid BW MUMIMO (“Signaling Scheme 2”), a new signaling may be used in accordance with an embodiment of the invention. One of the benefits of such a signaling scheme is that signaling overhead bits are reduced. In addition, STA relevant information can be completely present in a single user info field. Thus, a STA needs to parse only user info fields for which its AID matches to get complete information about its signal BW, sub-bands, starting stream index, total number of self streams and MCS. Limitations of this signaling scheme include (1) cannot work in environment with cross generation devices, and (2) cannot indicate different MCS, Nss and interference streams in different sub-bands within intended signal BW of a user.

In an embodiment, this signaling scheme is a completely new signaling scheme for WiFi 8, which consists of two parts, i.e., common info signaling and user info signaling, of a PPDU. These parts of the new signaling scheme for WiFi 8 are described below.

The common info signaling for the new signaling scheme for WiFi 8 may precede the user info signaling. The common info signaling indicates the total number of users present, which can be indicated separately (considering non-OFDMA signaling) or can be indicated through RU allocation field (considering OFDMA signaling).

The user info signaling for the new signaling scheme may succeed the common info signaling. The total number of user info fields is equal to the total number of users participating in the hybrid BW MUMIMO signal bandwidth. Each user info field contains the following information of a given user:

| Bit | Subfield | Number of subfields |
|---|---|---|
| B0-B10 | STA-ID | 11 |
| B11-B14 | MCS | 4 |
| B15-B17 | Number of streams | 3 |
| B18-B20 | Starting stream index | 3 |
| B21-B24 | Positioning pattern | 4 |

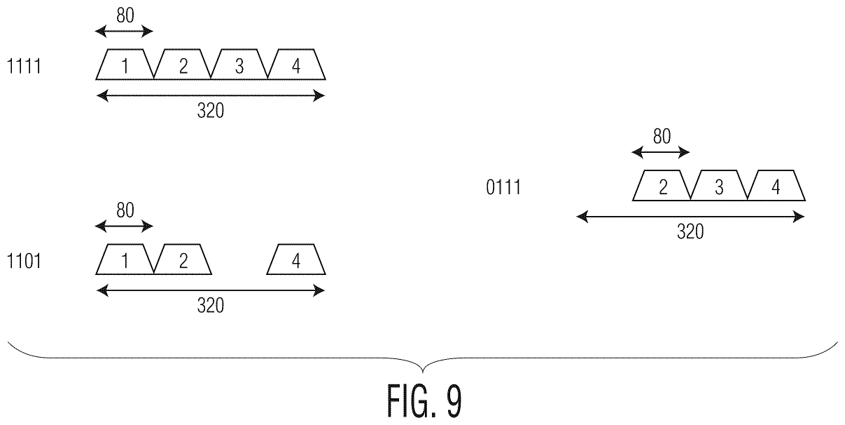

Positioning pattern in the user info field indicates the occupied sub-bands in the intended signal BW of the STA. As an example, each sub-band is considered to be of 80 MHz and total signal BW is 320 MHz. However, as noted above, the hybrid BW MUMIMO can be extended to sub-band of any BW and any signal BW. Each of the total 4 bits for positioning pattern corresponds to one sub-band. Thus, setting a bit to 1 (or 0) indicates whether the corresponding sub-band of 80 MHz is occupied or not. FIG. 9 illustrates different position patterns in accordance with an embodiment of the invention. As shown in FIG. 9, the positioning pattern of “1111” is used when all four (4) sub-bands are occupied. The positioning pattern of “1101” is used when only the third sub-band is not occupied. The positioning pattern of “0111” is used when only the first sub-band is not occupied.

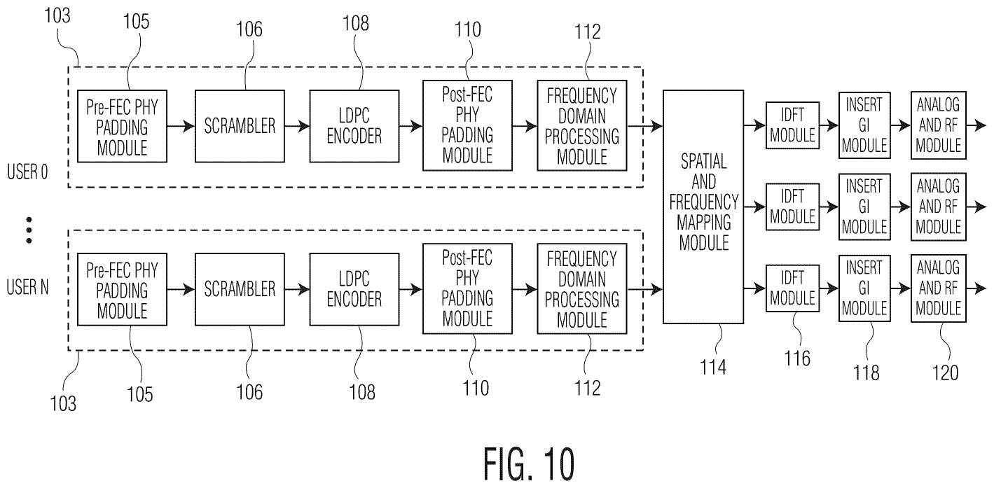

Turning now to FIG. 10, an AP transmitter (Tx) architecture for the hybrid BW MUMIMO in accordance with an embodiment of the invention is illustrated. The Tx architecture for data symbol construction of the hybrid BW MUMIMO is built on top of the Tx architecture for data symbol construction of the full BW MUMIMO.

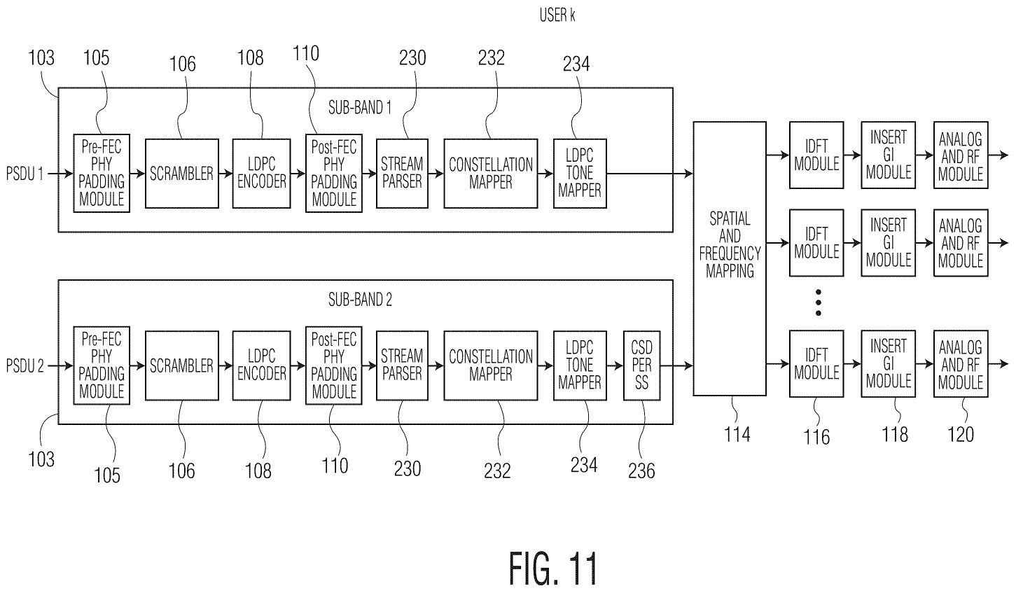

As shown in FIG. 10, the Tx architecture includes a data symbol construction unit 103 for each user among users 0-N. For each user, the data symbol construction unit 103 includes a pre-Forward Error Correction (FEC) PHY padding module 105, a scrambler 106, a low-density parity-check (LDPC) encoder 108, a post-FEC PHY padding module 110 and a frequency domain process module 112. For each user, these components process the received signal for the single user considering its MCS and Nss across sub-bands. For unequal Nss across sub-bands, segment parsing/deparsing will need proportional round-robin, which is described below. For unequal MCS across sub-bands, the processing will be described below with reference to FIG. 11.

After the post frequency domain processing module 112, the frequency domain symbols from each user are combined in the spatial and frequency mapping unit 114 as per its stream indices. In a given sub-band, only those users combined that span that sub-band will contribute frequency domain symbols in this sub-band. For each sub-band, the signals are processed by an inverse discrete Fourier transform (IDFT) module 116, an insert guard interval (GI) module 118 and an analog and RF module 120.

Turning now to FIG. 11, an AP transmitter (Tx) architecture for the hybrid BW MUMIMO for unequal MCS across sub-bands in accordance with an embodiment of the invention is illustrated. When a hybrid BW MUMIMO Tx enables different MCS in different sub-bands for a given user, the Tx signal construction may involve sending separate Physical Service Data Units (PSDUs) in separate sub-bands for this given user. For example, if a user k has two (2) sub-bands and the Tx enables different MCS in these two (2) sub-bands for the user k, the Tx signal construction may involve different processing blocks. As shown in FIG. 11, in this example, the data symbol construction unit 103 for a first PSDU (“PSDU 1”) includes the pre-FEC PHY padding module 105, the scrambler 106, the LDPC encoder 108, and the post-FEC PHY padding module 110. The data symbol construction unit 103 for the PSDU 1 further includes a stream parser 230, a constellation mapper 232 and an LDPC tone mapper 234. The data symbol construction unit 103 for a second PSDU (“PSDU 2”) also includes the pre-FEC PHY padding module 105, the scrambler 106, the LDPC encoder 108, the post-FEC PHY padding module 110, the stream parser 230, the constellation mapper 232 and the LDPC tone mapper 234. However, the data symbol construction unit 103 for the PSDU 1 further includes a cyclic shift diversity (CSD) per SS module 236.

In an embodiment, it is possible to perform frequency domain power normalization at the output of the spatial and frequency mapping unit 114. This is performed as follows. First, the max total number of users across sub-bands of Hybrid BW MUMIMO is set to be Nmax_user. The total number of users in a given sub-band i of the hybrid BW MUMIMO is set to be N_user[i]. The output of the spatial and frequency mapping unit 114 in the sub-band i is scaled by sqrt(Nmax_user/N_user[i]).

In all the past and present generations of WiFi technology, a user is allocated same number of streams across its entire signal BW. In High Efficiency (HE)/EHT OFDMA-MUMIMO, different streams could be present on different 80 MHz segments but the number of streams across a user's entire BW is still the same. To support different number of streams across BW for a user, transmitter (Tx)/receiver (Rx) architecture design as well as protocol/packet format changes are needed. These are described below.

In the case of single user (SU) or DL-OFDMA with SU of total signal BW (SigBW) transmission, say 160 MHz in WiFi, the user is experiencing different noise power in different parts of its intended BW. This could be due to some OBSS transmissions overlapping with some part of their intended BW or in general any other environment interference present only in a part of the user BW. In such a scenario, the user is able to successfully receive more number of data streams in the part of the BW that has low interference (or noise) and can receive lesser number of data streams successfully in the part of the BW that is experiencing high interference. Hence, there is a motivation to have a feature that can support different number of streams across the BW for this given user. Apart from extension of benefits described in the SU scenario, this feature when combined with the hybrid BW MUMIMO can provide additional throughput benefit.

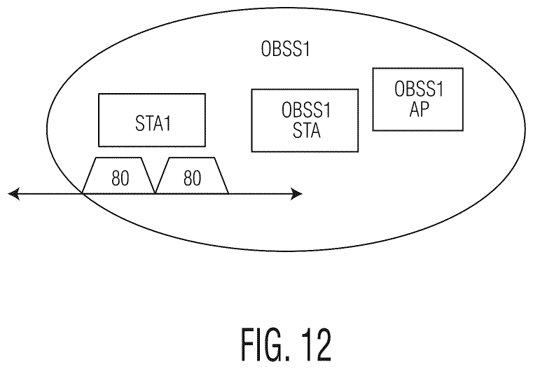

An example of a SU scenario in accordance with an embodiment of the invention is described with reference to FIG. 12. As shown in FIG. 12, the SU scenario involves an AP with four (4)/eight (8) antennas associated with one (1) STA (i.e., a STA1) with 2 Rx antennas. The STA1 is in a first OBSS (“OBSS1”) with an OBSS1 AP. For the AP, the entire 160 MHz is available. For the STA1, the device BW is 160 MHz and is available, but secondary 80 MHz channel is noisy, i.e., two (2) streams cannot be supported. Currently, WiFi 7 provides the following possible best configurations. The first option is 160 MHz SU with Nss1. The second option is 80 MHz SU with Nss2 in the primary 80 MHz.

With the unequal Nss support configuration in accordance with an embodiment of the invention, one stream data is on the primary 80 MHz and the two (2) stream data are on the secondary 80 MHz. The result may be 50% more throughput compared to current WiFi 7 best possible configurations.

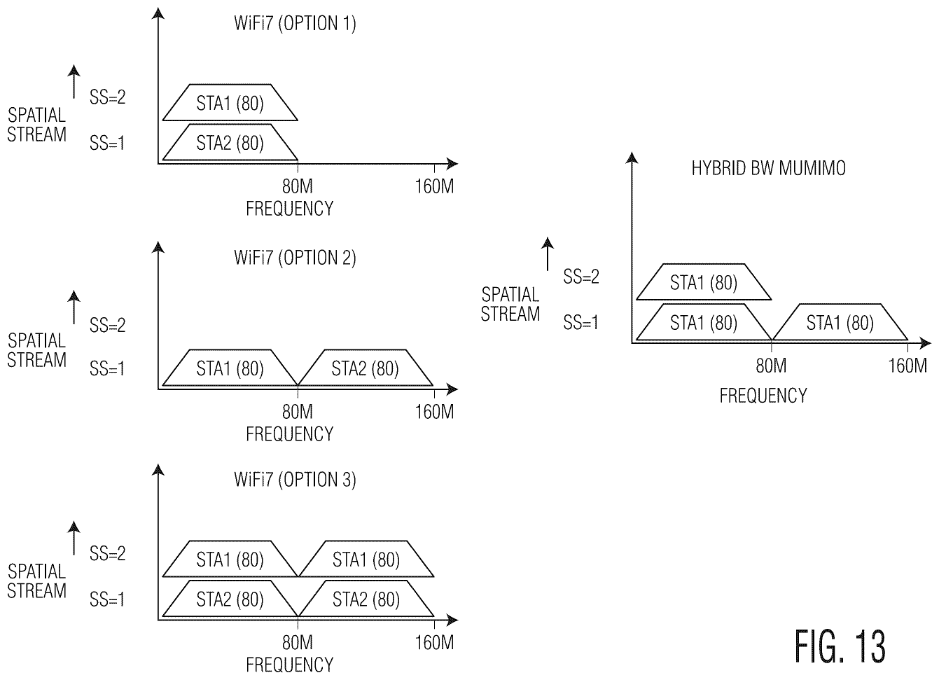

FIG. 13 illustrates the throughput for current three (3) WiFi 7 options and the SU with unequal Nss. For the WiFi 7 (Option 3), because the secondary 80 MHz is noisy, the 2^{nd} stream is highly error prone in the secondary 80 MHz and thus the effective throughput for this case will be quite low.

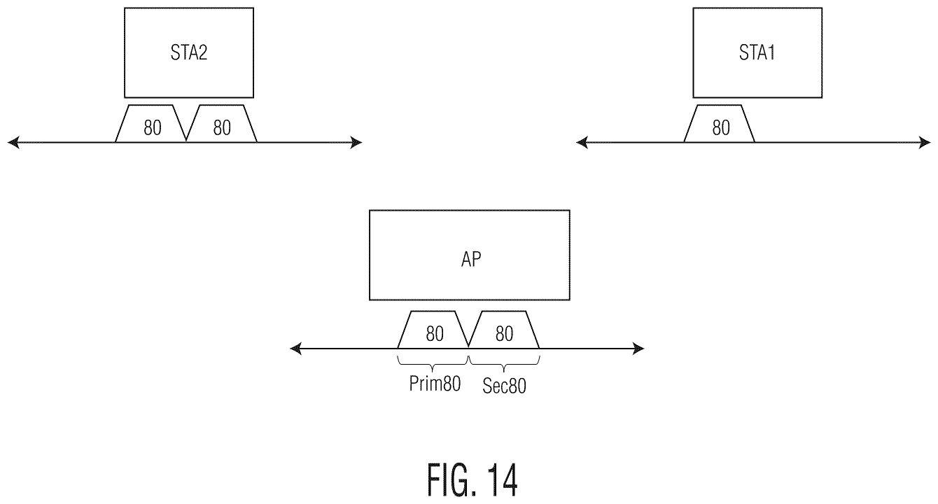

An example of a hybrid MUMIMO with unequal Nss SU scenario in accordance with an embodiment of the invention is described with reference to FIG. 14. As shown in FIG. 14, this scenario involves an AP with four (4)/eight (8) antennas associated with two (2) STAs (i.e., a STA1 with one (1) Rx and a STA2 with two (2) Rx). For the AP, the entire 160 MHz is available. For the STA1, the device BW is 80 MHz and is available. For the STA2, the device BW is 160 MHz and is available. Currently, WiFi 7 provides the following possible best configurations. The first option is spatial multiplex the STA1 (SS=1) and the STA2 (SS=2) in the primary 80 MHz. The second option is pure OFDMA with the STA1 in the primary 80 MHz and the STA2 in the secondary 80 MHz.

The hybrid BW MUMIMO provides the following possible best configuration, which is spatially multiplex the STA2 in the entire 160 MHz for stream index 1 and the STA1 in the primary 80 MHz for stream index 2 in the entire 160 MHz. As a result, the hybrid BW MUMIMO can provide 100% more total system throughput as compared to current WiFi 7.

The hybrid BW MUMIMO with the unequal Nss across band for a given support provides the following possible configuration, which is spatially multiplex the STA1 and the STA2 on the primary 80 MHz with one (1) SS each and two (2) SS for the STA2 on the secondary 80 MHz. This configuration is 50% more throughput for the STA2 compared to only the hybrid BW MUMIMO and 150% more compared to current WiFi 7.

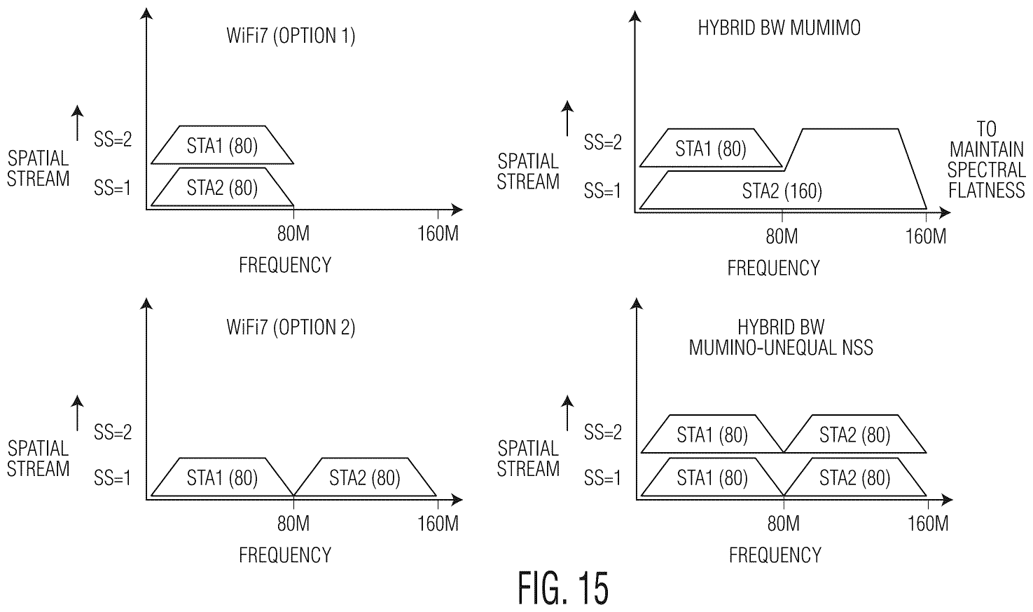

FIG. 15 illustrates the throughput for current two (2) WiFi 7 options, the hybrid BW MUMIMO and the hybrid BW MUMIMO with the unequal Nss support configuration. As illustrated, the hybrid BW MUMIMO can provide 100% more total system throughput as compared to current WiFi 7 options and the hybrid BW MUMIMO with the unequal Nss support configuration can provide 150% more throughput as compared to current WiFi 7 options.

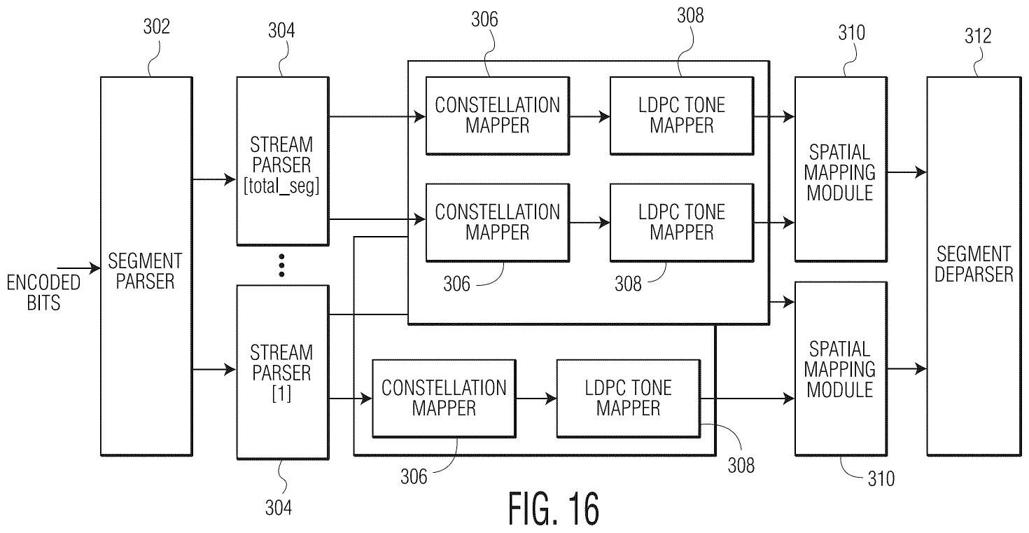

Turning now to FIG. 16, a TX architecture for unequal streams support in accordance with an embodiment of the invention is shown. For the description of the TX architecture, the following notations are used:
Nss[seg_id]: Total number of streams in segment index seg_id
s=max{1, N_{BPSCS}/2}
total_seg: total no. of 80 MHz segments
Total number of stream parsers: total_seg
Nsd_80=980 (High Efficiency Wifi (HEW)/EHT)

As illustrated in FIG. 16, a spatial mapping module 310 is configured on per segment basis. For segment index seg_id, its configuration is determined by Nss[seg_id]. A segment parser 302 sends s*Nss[1] bits to a stream parser [1] 304, followed by s*Nss[2] bits to a stream parser [2] 304 . . . and followed by s*Nss[total_seg] bits to a stream parser [total_seg] 304 in a round robin fashion. A stream parser [k] 304 sends s bits to stream 1 followed by s bits to stream 2 . . . followed by s bits to stream Nss[seg_id] in a round robin fashion. Each stream is processed by a constellation mapper 306 and an LDPC tone mapper 308. A segment deparser 312 operates on the output of multiple spatial mapping matrix and arranges them sequentially. In particular, the segment deparser 312 selects Nsd_80 vectors from the spatial mapping module output of the stream parser [1] 304, followed by Nsd_80 vectors from the spatial mapping module output of the stream parser [2] 304 . . . and then followed by Nsd_80 vectors from the spatial mapping module output of the stream parser [total_seg] 304 in a round robin fashion.

No. of HE/EHT/UHR Long Training Fields (LTFs) (which is denoted by “NLTF_total”) is determined by Nss_max=max(Nss[seg_id)) across segments and whether LTF duplication is enabled as per table below.

| | No. of LTFs when LTF | No. of LTFs when LTF |
|---|---|---|
| Nss_max | duplication is disabled | duplication is enabled |
| 1 | 1 | 2 |
| 2 | 2 | 4 |
| 3 | 4 | 8 |
| 4 | 4 | 8 |
| 5 | 6 | 12 |
| 6 | 6 | 12 |
| 7 | 8 | 16 |
| 8 | 8 | 16 |

For P Matrix Support, the no. of HE/EHT/UHR LTFs remains same across segments. The P matrix used on segment index seg_id may be denoted by P[seg_id]. HE/EHT/UHR LTFs generated in segment index seg_id uses P[seg_id] matrix. P[seg_id] is a submatrix of dimension Nss[seg_id]×NLTF_total of HE/EHT/UHR standard defined P matrix of dimension Nss_max×NLTF_total.

One may extend the architecture shown in FIG. 16 to further allow different user BW segments to have different modulation together with different number of streams. The Tx architecture to support the same follows the same process as described before with the following modifications:
(a) s[i,seg_id]=max{1, N_{BPSCS}[i,seg_id]/2}, where s[i,seg_id] is number of bits mapped to real (or imaginary) part of tone for i^{th} stream for segment index seg_id,
(b) the segment parser 302 sends sumᵢ^{1_to_Nss[1]} (s[i,1]) bits to the stream parser [1] 304, followed by sumᵢ^{1_to_Nss[2]} (s[i,2]) bits to the stream parser [2] 304 . . . and then followed by sumᵢ^{1_to_Nss[total_seg]} (s[i,total_seg]) bits to the stream parser [total_seg] 304 in a round robin fashion.

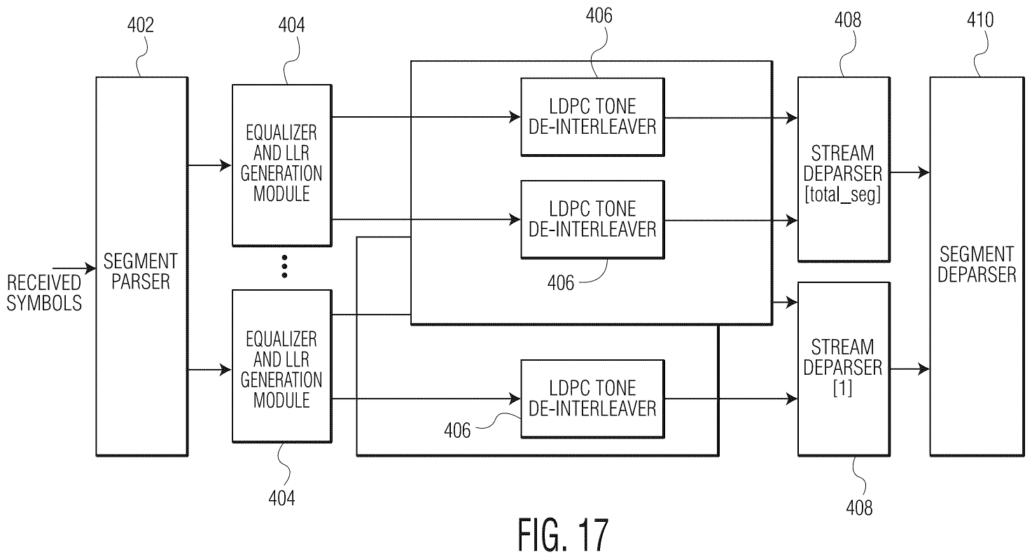

Turning now to FIG. 17, an RX architecture for different numbers of streams per 80 MHz band for SU in accordance with an embodiment of the invention is shown. As illustrated in FIG. 17, a segment parser 402 sends Nsd_80 vectors of received symbols to an equalizer and Log-Likelihood Ratio (LLR) generation module 404 corresponding to segment[1], next Nsd_80 vectors of received symbols to the equalizer and LLR generation module 404 corresponding to segment[2] . . . and Nsd_80 vectors to the equalizer and LLR generation module 404 corresponding to segment[total_seg] in a round robin fashion. Each stream is processed by an LDPC tone de-interleaver 406. A stream deparser [k] 408 is configured on per segment basis. The stream deparser 408 picks s LLRs for stream 1, s LLRs for stream 2 and so on in a round robin fashion. A segment deparser 410 picks s*Nss[1] LLRs from a stream deparser[1], s*Nss[2] LLRs from stream deparser[2], . . . and s*Nss[total_seg] LLRs from a stream deparser[total_seg] 408 in round a robin fashion and assembles them in sequence.

For P matrix support, the RX may determine the number of LTFs either from Nss_max=max(Nss[seg_id)) across segments or directly from NLTFs field information from the preamble portion of packet (if present). LTFs generated in segment index seg_id uses P[seg_id] matrix, where P matrix used on segment index seg_id is denoted by P[seg_id]. To undo P matrix at the receiver end, the dimensions of the P matrix for that segment are retrieved as Nss[seg_id]×NLTF_total from the preamble symbols corresponding to the Wifi standard for it is intended.

One may extend the architecture shown in FIG. 17 to further allow different user BW segments to have different modulation together with different number of streams. The Rx architecture to support the same follows the same process as described before with the following modifications:
(a) s[i,seg_id]=max{1, N_{BPSCS}[i,seg_id]/2}, where s[i,seg_id] is number of bits mapped to real (or imaginary) part of tone for i^{th} i stream for segment index seg_id,
(b) the segment deparser 410 picks sumᵢ^{1_to_Nss[1]} (s[i,1]) bits of the stream parser [1]408, followed by sumᵢ^{1_to_Nss[2]} (s[i,2]) bits of the stream parser [2] 304 . . . and followed by sumᵢ (s[i,total_seg]) bits of the stream parser [total_seg] 304 in a round robin fashion and assembles them in sequence.

In this disclosure, the Tx side and Rx architecture to support different number of streams across BW for a given user have been described. The present disclosure assumes the minimum granularity of BW of 80 MHz that has constant number of streams for a given user. However, the general idea of the disclosure can be extended to any general granularity of the BW having constant number of streams. The minimum granularity of BW resolution for unequal number streams can be extended from 80 MHz to 20 MHz/40 MHz/160 MHz, etc. The general idea of this disclosure will hold in such cases.

The main architecture changes as compared to current WiFi standards include swapping of stream parser and segment parser blocks on Tx/Rx side, spatial Mapping matrix (P matrix) support.

In an embodiment, the DL-OFDMA packet format of WiFi 7/8 (or beyond) standard may be reused. In this embodiment, one of the preamble bits (px) is set indicating that current packet is having unequal stream across BW (px could be one of the disregard bits of USIG/EHTSIG if WiFi 7 DL-OFDMA packet format is used). For the RU allocation field, the user BW is divided into multiple RUs such that each RU size corresponds to the part of the BW having constant number of streams. This RU distribution is used to set the RU allocation field corresponding to single user (as per the respective standard). The following protocols may be used for the user info field. For the AID field, the AID of the given user is repeated in all user info fields. In the Nss field, the number of streams in this RU segment for the given user is indicated. It is also possible to indicate different MCS, FEC etc. in different RU segments for a given user.

One of the benefits of using unequal Nss is that it can enable EHT STAs to participate in DL-OFDMA (non MIMO) transactions with WiFi 8 STAs. Thus, it assists in enabling parallel communication with cross generation devices present in the environment. In addition, limited redesign is needed at Tx/Rx (compared to WiFi 7 design) to interpret and process the signal. For Rx processing, from the preamble portion (preamble bit px), WiFi 8 (or beyond) STA understands that incoming packet is having SU transactions with unequal stream across BW. Also, this packet is in DL-OFDMA format. Also, from the common field, after reading “RU allocation”, a STA understands how the entire SigBW is divided into different RU segments. Further, a WiFi 8 STA can read each and every user info field and compare its AID with AID of user info fields. For all the user info fields whose AID matches with the WiFi 8 STA AID, the WiFi 8 STA can understand the corresponding RU is allocated to it. The WiFi 8 STA can understand that data in the RU whose AID matches with its AID is using the Nss/MCS/FEC as per the Nss/MCS/FEC fields of the corresponding user info field.

Currently, sounding feedback is defined on per user basis, i.e., Tone Grouping (Ng), Codebook (CB) size, Feedback Type (SU/MU) and number of columns of steering matrix of the Beamformee feedback (Nc) remain same for a STA across its entire BW (partial BW info) in the STA info field of a Null Data Packet (NDP) announcement frame. As an example, the NDP announcement frame may include the following fields: AID11 (11 bits), Partial BW Info (9 bits), Reserved (1 bit), Nc Index (4 bits), Feedback Type and Ng (2 bits), Disambiguation (1 bit), Codebook size (1 bit) and Reserved (3 bits).

To enable cases where UHR and EHT STAs are to participate together with WiFi 8 or beyond compatible STAs (that support unequal streams across BW), sounding with a single NDP announcement frame format can be done as follows. For a STA having Nss varying across its RU, multiple STA info fields for the same STA are present in the NDP announcement. STA RU is divided into multiple sub-RUs such that Nss across that RU remains constant. Separate STA info field is created for each sub-RU. AID of this STA is repeated in these multiple STA info fields. Partial BW info for each STA info field corresponds to different sub-RUs. Beamformer requests different Feedback Type (SU/MU), Nc, CB size, and Ng for these sub-RUs. Lastly, a UHR STA as Beamformee parses multiple STA info fields. In case of WiFi 8 or beyond STAs, it is possible that its AID could match the AID field of more than one STA info field. It thus collates information from these multiple STA info fields to get complete information of the number of streams per RU and the kind of feedback in (number of streams) each sub-RU that Beamformer is requesting.

Another method is to reuse the EHT station field format without replicating STA ID in multiple STA info fields, i.e., each STA has up to one (1) STA info field corresponding to its AID. In this method, the Beamformer will always request for MU feedback. The Nc, Ng and CB size for which feedback is requested will be:
Nc: max(Nc) across STAs entire RU,
Ng: min(Ng) across STAs entire RU, and
CB size: max(CB size) across STAs entire RU.

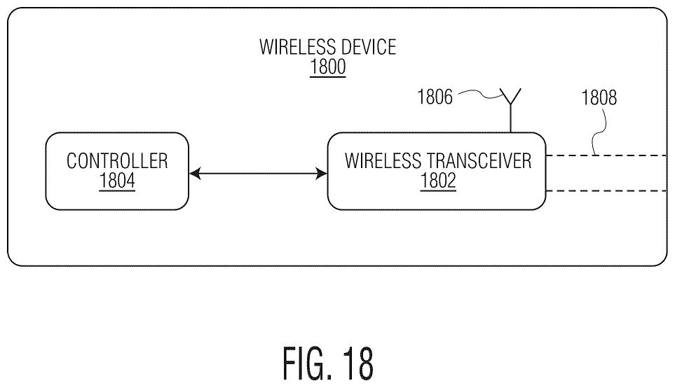

FIG. 18 depicts a wireless device 1800 in accordance with an embodiment of the invention. The wireless device 1800 can be used in the multi-link communications system 100 depicted in FIG. 1. For example, the wireless device 1800 may be an embodiment of the AP MLD 102 or the non-AP STA MLD 104 depicted in FIG. 1.

In the embodiment depicted in FIG. 18, the wireless device 1800 includes a wireless transceiver 1802, a controller 1804 operably connected to the wireless transceiver, and at least one antenna 1806 operably connected to the wireless transceiver. In some embodiments, the wireless device 1800 may include at least one optional network port 1808 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1800 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

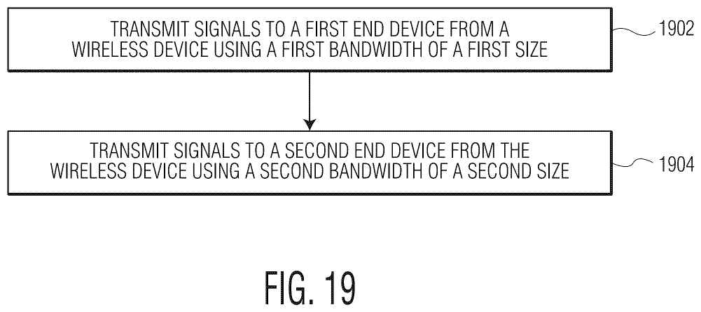

A method of transmitting signals to different end devices from a wireless device in a communications system in accordance with an embodiment of the invention is described with reference to a flow diagram of FIG. 19. At block 1902, transmitting the signals to a first end device from the wireless device using a first bandwidth of a first size. At block 1904, transmitting the signals to a second end device from the wireless device using a second bandwidth of a second size.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A wireless device comprising:
a wireless transceiver arranged to receive and transmit signals; and
a controller operably coupled to the wireless transceiver to process the signals, wherein the controller is configured to transmit the signals to different end devices using different sized bandwidths, wherein the signals transmitted to a first end device use a first bandwidth of a first size and the signals transmitted to a first end device use a second bandwidth of a second size.

2. The wireless device of claim 1, wherein the controller is configured to transmit the signals to different end devices on different spatial streams using different sized bandwidths.

3. The wireless device of claim 1, wherein the controller is configured to use a universal signal (USIG) to transmit information associated with transmission of the signals to the different end devices using the different sized bandwidths.

4. The wireless device of claim 1, wherein the controller is configured to use an Extreme High Throughput Signal (EHTSIG) to transmit information associated with transmission of the signals to the different end devices using the different sized bandwidths.

5. The wireless device of claim 1, wherein the controller is configured to use at least one new field of a Physical Layer Convergence Protocol (PLCP) Protocol Data Unit (“PPDU”) to transmit information associated with transmission of the signals to the different end devices using the different sized bandwidths.

6. The wireless device of claim 5, wherein the controller is configured to use a new common info field and a new user info field of the PPDU to transmit information associated with transmission of the signals to the different end devices using the different sized bandwidths.

7. The wireless device of claim 6, wherein the new common info field indicates a total number of end devices present.

8. The wireless device of claim 6, wherein the controller is configured to use multiple user info fields of the PPDU equal to the number of the different end devices, and wherein each of the multiple user info fields includes information of a specific end device.

9. The wireless device of claim 1, wherein the controller is configured to transmit the signals to the different end devices using different numbers of spatial streams for each end device.

10. A method of transmitting signals to different end devices from a wireless device in a communications system, the method comprising:
transmitting the signals to a first end device from the wireless device using a first bandwidth of a first size; and
transmitting the signals to a second end device from the wireless device using a second bandwidth of a second size.

11. The method of claim 10, wherein transmitting the signals to the second end device from the wireless device includes transmitting the signals to the second end device on different spatial streams using different sized bandwidths.

12. The method of claim 10, further comprising utilizing a universal signal (USIG) to transmit information associated with transmission of the signals to the first and second end devices.

13. The method of claim 10, further comprising utilizing an Extreme High Throughput Signal (EHTSIG) to transmit information associated with transmission of the signals to the first and second end devices.

14. The method of claim 10, further comprising utilizing at least one new field of a Physical Layer Convergence Protocol (PLCP) Protocol Data Unit (“PPDU”) to transmit information associated with transmission of the signals to the first and second end devices.

15. The method of claim 14, wherein utilizing the at least one new field of the frame includes utilizing a new common info field and a new user info field of the PPDU to transmit the information associated with the transmission of the signals to the first and second end devices.

16. The method of claim 15, wherein the new common info field indicates a total number of end devices present.

17. The method of claim 15, wherein utilizing the at least one new field of the frame includes utilizing multiple user info fields of the PPDU equal to the number of the different end devices, and wherein each of the multiple user info fields includes information of a specific end device.

18. The method of claim 10, wherein transmitting the signals to the first and second end devices from the wireless device includes transmitting the signals to the first and second end devices using different numbers of spatial streams.

19. A wireless device comprising:
a wireless transceiver arranged to receive and transmit signals; and
a controller operably coupled to the wireless transceiver to process the signals, wherein the controller is configured to spatially multiplex the signals to different end devices using different sized bandwidths in a total available bandwidth, wherein the signals transmitted to a first end device use a first bandwidth of a first size and the signals transmitted to a second end device use a second bandwidth of a second size.

20. The wireless device of claim 19, wherein the controller is configured to transmit the signals to the different end devices using different numbers of spatial streams such that a first number of spatial streams is used for one of the different end devices and a second number of spatial streams is used for another one of the different end devices.
